(19) United States
(12) Patent Application Publication
(10) Pub. No.: US 2008/0059764 A1
(43) Pub. Date: Mar. 6, 2008

(54) Integral parallel machine

(76) Inventor: Gheorghe Stefan, Nashua, NH (US)

Correspondence Address: HAVERSTOCK & OWENS LLP, 162 N WOLFE ROAD, SUNNYVALE, CA, 94086, US

(21) Appl. No.: 11/897,825

(22) Filed: Aug. 31, 2007

Related U.S. Application Data
(60) Provisional application No. 60/841,888, filed on Sep. 1, 2006.

(51) Int. Cl. G06F 15/76; G06F 9/02

(52) U.S. Cl. 712/28; 712/32; 712/E09.002

(57) ABSTRACT

The present invention is an integral parallel machine for performing intensive computations. By combining data parallelism, time parallelism and speculative parallelism where data parallelism and time parallelism are segregated, efficient computations can be performed. Specifically, for sequential functions, the time parallel system in conjunction with an implementation for speculative parallelism is able to handle the sequential computations in a parallel manner. Each processing element in the time parallel system is able to perform a function and receives data from a prior processing element in the pipeline. Thus, after a latency period for filling the pipeline, a result is produced after clock cycle or other desired time period.

### RELATED APPLICATION(S)

This Patent Application claims priority under 35 U.S.C. §119(e) of the co-pending, co-owned U.S. Provisional Patent Application No. 60/841,888, filed Sep. 1, 2006, and entitled “INTEGRAL PARALLEL COMPUTATION” which is also hereby incorporated by reference in its entirety.

### FIELD OF THE INVENTION

The present invention relates to the field of data processing. More specifically, the present invention relates to data processing using data parallel computation, time parallel computation and speculative parallel computation.

### BACKGROUND OF THE INVENTION

Computing workloads in the emerging world of “high definition” digital multimedia (e.g. HDTV and HD-DVD) more closely resembles workloads associated with scientific computing, or so called supercomputing, rather than general purpose personal computing workloads. Unlike traditional supercomputing applications, which are free to trade performance for super-size or super-cost structures, entertainment supercomputing in the rapidly growing digital consumer electronic industry imposes extreme constraints of both size, cost and power.

With rapid growth has come rapid change in market requirements and industry standards. The traditional approach of implementing highly specialized integrated circuits (ASICs) is no longer cost effective as the research and development required for each new application specific integrated circuit is less likely to be amortized over the ever shortening product life cycle. At the same time, ASIC designers are able to optimize efficiency and cost through judicious use of parallel processing and parallel data paths. An ASIC designer is free to look for explicit and latent parallelism in every nook and cranny of a specific application or algorithm, and then exploit that in circuits. With the growing need for flexibility, however, an embedded parallel computer is needed that finds the optimum balance between all of the available forms of parallelism, yet remains programmable.

Embedded computation requires more generality/flexibility than that offered by an ASIC, but less generality than that offered by a general purpose processor. Therefore, the instruction set architecture of an embedded computer can be optimized for an application domain, yet remain “general purpose” within that domain.

### SUMMARY OF THE INVENTION

An integral parallel machine incorporates data parallelism, time parallelism and speculative parallelism where data and time parallelism separated with speculative parallelism incorporated in each. By providing a system with both data parallelism and time parallelism, issues that require more than data parallelism are able to be handled. Time parallelism is particularly valuable for processing sequential data. Furthermore, since the time parallelism system is a pipeline of processing elements that run sequentially, speculative parallelism is utilized to ensure the pipeline functions properly without stalls (or bubbles). With each processing element being programmable, the functionality of the integral parallel machine is very flexible.

### BRIEF DESCRIPTION OF THE DRAWINGS

FIG. 1 illustrates a block diagram of an integral parallel machine.

FIG. 2 illustrates a block diagram of a data parallel system.

FIG. 3A illustrates a block diagram of a linear time parallel system.

FIG. 3B illustrates a block diagram of a looped time parallel system.

FIG. 4 illustrates a flowchart of a method of using a sequential pipeline of processing elements to process data in parallel.

### DETAILED DESCRIPTION OF THE PREFERRED EMBODIMENT

An Integral Parallel Machine (IPM) incorporates data parallelism, time parallelism and speculative parallelism but separates or segregates each. In particular, data parallelism and time parallelism are separated with speculative parallelism in each. The mixture of the different kinds of parallelism is useful in cases that require multiple kinds of parallelism for efficient processing.

An example of an application for which the different kinds of parallelism are required but are preferably separated is a sequential function. Some functions are pure sequential functions such as f(h(x)). The important aspect of a pure sequential function is that it is impossible to compute f before computing h since f is reliant on h. For such functions, time parallelism can be used to enhance efficiency which becomes very crucial. By understanding that it is possible to turn a sequential pipe into a parallel processor, a pipeline of sequential machines can be used to compute sequential functions very efficiently.

For example, two machines in sequence are used to compute f(h(x)). The machines include a first machine computing h is coupled to a second machine computing f. A stream of operands, x₁, x₂, . . . xₙ, is processed such that h(x₁) is processed by the first machine while the second machine computing f performs no operation in the first clock cycle. Then, in the second clock cycle, h(x₂) is processed by the first machine, and f(h(x₁)) is processed by the second machine. In the third clock cycle, h(x₃) is processed while f(h(x₂)) is processed. The process continues until f(h(xₙ)) is computed. Thus, aside from a small latency required to fill the pipeline (a latency of two in the above example), the pipeline is able to perform computations in parallel for a sequential function and produce a result in each clock cycle, thereafter.

For a set of sequential machines to work properly as a parallel machine, the set preferably functions without interruption. Therefore, when confronted with a situation such as:

c=c[0]?c+(a+b):c+(a−b),

not only is time parallelism important but speculative parallelism is as well. The code above is interpreted to mean that if a Least Significant Bit (LSB) of c is 1, then set c equal to c+(a+b), but if the LSB of c is 0, then set c equal to c+ (a−b). Typically, the value of c is determined first to find out if it is a 0 or 1, and then depending on the value of c, b would either be added to a, or b would be subtracted from a. However, by performing the functions in such an order would cause an interruption in the process as there would be a delay waiting to determine the value of c to determine which branch to take. This is not an efficient to parallel system. If clock cycles are wasted waiting for a result, the system is no longer functioning in parallel at that point. The solution to this problem is referred to as speculative parallelism. Both a+b and a−b are calculated by a machine in the set of machines, and then the value of c is used to select the proper result after they are both computed. Thus, there is no time spent waiting, and the sequence continues to be processed in parallel.

To implement a sequential pipeline to perform computations in parallel, each processing element in a sequential pipeline is able to take data from any of the previous processing elements. Therefore, going back to the example of using c[0] to determine a+b or a−b, in a sequence of processing elements, a first processing element stores the data of c[0]. A second processing element computes c+(a+b). A third processing element computes c+(a−b). A fourth processing element takes the proper value from either the second or third processing element depending on the value of c[0]. Thus, the second and third processing elements are able to utilize the information received from the first processing element to perform their computations. Furthermore, the fourth processing element is able to utilize information from the second and third processing elements to make its computation or selection.

To select previous processing elements, preferably a selector/multiplexer is used, although in some embodiments, other mechanisms are implemented. In an alternative embodiment, a file register is used. Preferably, it is possible to choose from 8 previous processing elements, although fewer or more processing elements are possible.

The following is a description of the components of the IPM. A memory is used to store data and programs and to organize interface buffers between all sub-systems. Preferably, a portion of the memory is on chip, and a portion of it is on external RAM. An input-output system includes general purpose interfaces and, if desired, application specific interfaces. A host is one or more general purpose controllers used to control the interaction with the external world or to run sequential operations that are neither data intensive nor time intensive. A data parallel system is an array of processing elements interconnected by a simple network. A time parallel system with speculative capabilities is a dynamically reconfigurable pipe of processing elements. In each clock cycle, new data is inserted into the pipe of processing elements. In a pipe with n blocks, it is possible to do n computations in parallel. As described above there is an initial latency, but with a large amount of data, the latency is negligible. After the latency period, each clock cycle produces a single result.

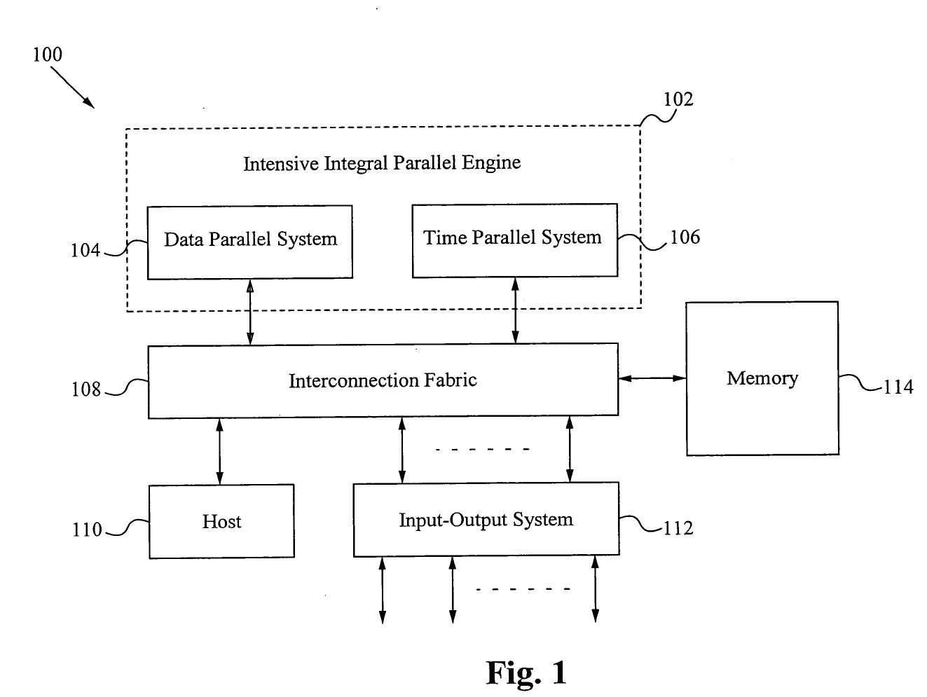

The IPM is a “data-centric” design. This is in contrast with most general purpose high-performance sequential machines, which tend to be “program-centric.” The IPM is organized around the memory in order to have maximum flexibility in partitioning the overall computation into tasks performed by different complementary resources. P FIG. 1 illustrates a block diagram of an Integral Parallel Machine (IPM) 100. The IPM 100 includes an intensive integral parallel engine 102 an interconnection fabric 108, a host 110, an Input-Output (I/O) system 112 and a memory 114. The intensive integral parallel engine 102 is the core containing the parallel computational resources. The intensive integral parallel engine 102 implements the three forms of parallelism (data, time and speculative) segregated in two subsystems—a data parallel system 104 and a time parallel system 106.

The data parallel system 104 is an array of processing elements interconnected by a simple network. The data parallel system 104 issues, in each clock cycle, an instruction. The instruction is broadcast into the array for performing a function. The data parallel system 104 is described further in U.S. Pat. No. 7,107,478, entitled DATA PROCESSING SYSTEM HAVING A CARTESIAN CONTROLLER, and U.S. Patent Publ. No. 2004/0123071, entitled CELLULAR ENGINE FOR A DATA PROCESSING SYSTEM, which are hereby incorporated by reference in their entirety.

The time parallel system 106 is a dynamically reconfigurable pipe of processing elements. Each processing element in the data parallel system 104 and the time parallel system 106 is individually programmable.

The memory 114 is used to store data and programs and to organize interface buffers between all of the sub-systems. The I/O system 112 includes general purpose interfaces and, if desired, application specific interfaces. The host 110 is one or more general purpose controllers used to control the interaction with the external world or to run sequential operations that are neither data intensive nor time intensive.

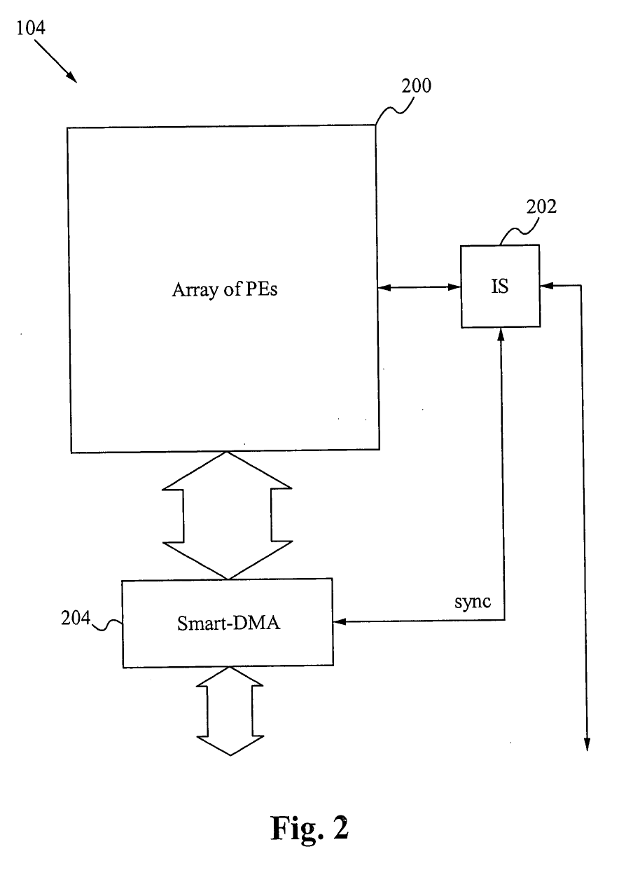

FIG. 2 illustrates a block diagram of a data parallel system 104. The data parallel system 104 includes an array of processing elements 200, an instruction sequencer 202 and a Smart-DMA 204. The processing elements 200 in the array execute an instruction broadcast by the instruction sequencer 202. The instruction sequencer 202 generates an instruction each clock cycle. The instruction sequencer 202 also interacts with the Smart-DMA 204. The Smart-DMA 204 is an I/O machine used to transfer data between the array of processing elements 200 and the rest of the system. Specifically, the Smart-DMA 204 transfers the data to and from the memory 114 (FIG. 1).

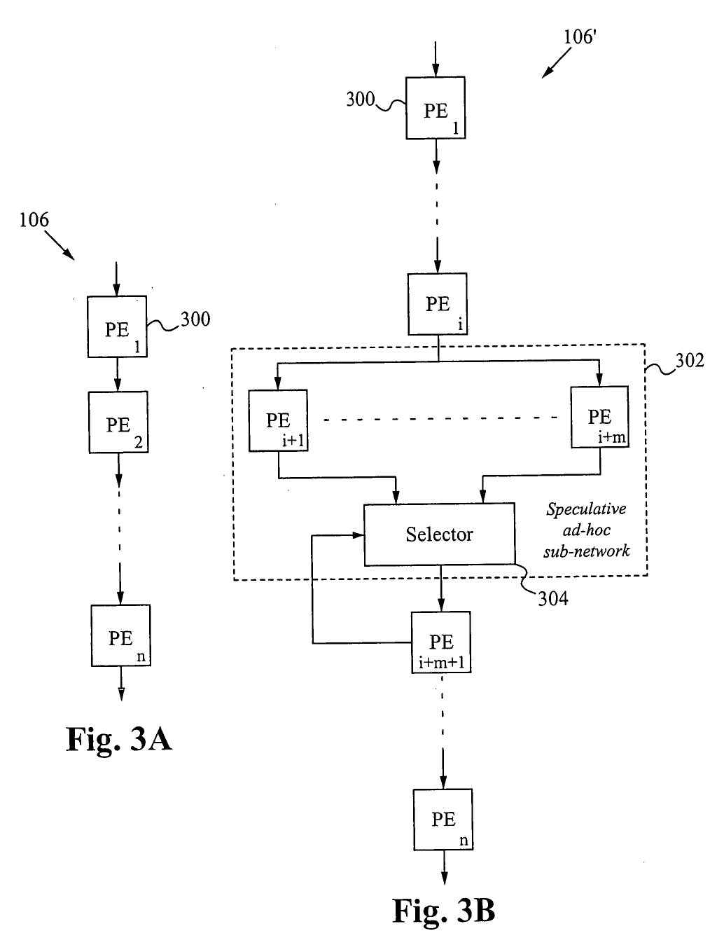

FIG. 3A illustrates a block diagram of a linear time parallel system 106. The linear time parallel system 106 is a line of processing elements 300. In each clock cycle, new data is inserted. Since there are n blocks, it is possible to do n computations in parallel. As described above, there is an initial latency, but typically the latency is negligible. After the latency period, each clock cycle produces a single result. The time parallel system 106 is a dynamically configurable system. Thus, the linear pipe can be reconfigured at the clock cycle level in order to provide “cross configuration” as is shown in FIG. 3B.

As described above, each processing element 300 is able to be configured to perform a specified function. Information, such as a stream of data, enters the time parallel system 106 at the first processing element, PE₁, and is processed in a first clock cycle. In a second clock cycle, the result of PE₁ is sent to PE₂, and PE₂ performs a function on the result while PE₁ receives new data and performs a function on the new data. The process continues until the data is processed by each processing element. Final results are obtained after the data is processed by PEₙ.

FIG. 3B illustrates a block diagram of a looped time parallel system 106′. The looped time parallel system 106′ is similar to the linear time parallel system 106 with a speculative sub-network 302. To efficiently enable more complex processing of data including computing branches such as c=c[0]? c+(a+b): c+(a−b), the speculative sub-network 302 is used. A selection component 304 such as a selector, multiplexor or file register is used to provide speculative parallelism. The selection component 304 allows a processing element 300 to select input data from a previous processing element that is included in the speculative sub-network 302.

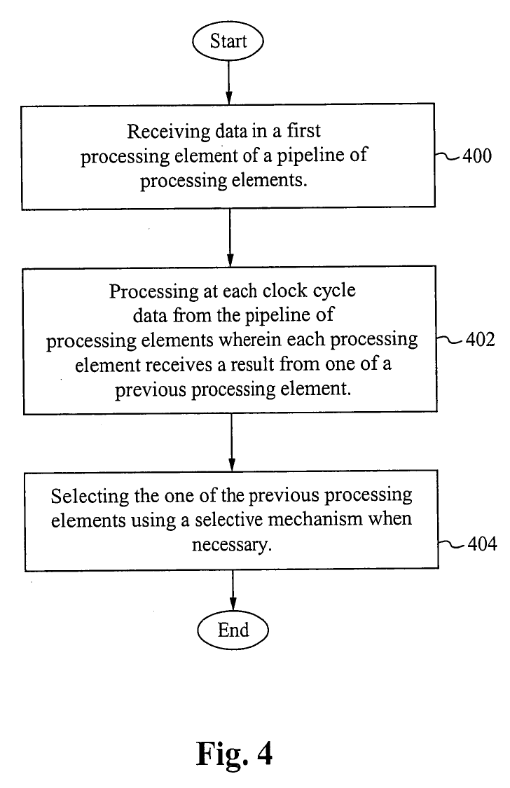

FIG. 4 illustrates a flowchart of a method of using a sequential pipeline of processing elements to process data in parallel. In the step 400, a first processing element of a pipeline of processing elements receives data. The data is preferably a large amount of sequential data such as a video stream. In the step 402, at each clock cycle, data in the pipeline of processing elements is sequentially processed. Each processing element receives a result from one of a previous processing element. Therefore, after a latency period, n processing elements process a function each clock cycle. In the step 404, the one of the previous processing elements is selected using a selection component when necessary. If the processing element is to receive data from its immediately previous processing element, then a selection mechanism is unnecessary for that particular processing element. However, for processing elements that selectively choose which result from a previous processing element to receive, a selection mechanism is implemented. After the data is processed by the time parallel system, it is sent to the data parallel system for further processing.

Within the data parallel system several design elements are preferred. Strong data locality of the algorithms allows processing elements to be coupled in a compact linear array with nearest neighbor connections. The number of 16-bit processing elements is preferably between 256 and 1024. Each processing element contains a 16-bit ALU, an 8-word register file, a 256-word data memory and a boolean machine with an associated 8-bit state register. Since cycle operations are add and subtract on 16-bit integers, a small number of additional single-clock instructions support efficient (multi-cycle) multiplication. The I/O is a 2-D network of shift registers with one register per processing element. Two or more independent (stack-based) instruction sequencers including one or more 32-bit instruction sequencers that sequence arithmetic and logic instructions into the array of processing elements and a 32/128-bit stack-based I/O controller (or “Smart-DMA”) are used to transfer data between an I/O plan and the rest of the system which results in a Single Instruction Multiple Data (SIMD)-like machine for one instruction sequencer or a Multiple Instruction Multiple Data (MIMD) of SIMD machine for more than one instruction register. A Smart-DMA and the instruction sequencer communicate with each other using interrupts. Data exchange between the array of the processing elements and the I/O is executed in one clock cycle and is synchronized using a sequence of interrupts specific to each kind of transfer. An instruction sequencer instruction is conditionally executed in each processing element depending on a boolean test of the appropriate bit in the state register.

The time parallel system includes a dynamically reconfigurable pipeline of n processing elements. The value of n preferably falls within the range of 8 and 63, and the pipeline can reshape dynamically into a logical “cross” configuration as described above.

To utilize the present invention, an integral parallel machine includes a data parallel system and a time parallel system which both are capable of implementing speculative parallelism. The time parallel system receives data input from a memory and performs processing in a pipeline where each processing element performs a function after receiving a result from one of the previous processing elements. The time parallel system then sends the computed results to the data parallel system for further computation. The time parallel system can send data to the data parallel system as well.

In operation, the present invention is able to be used independently or as an accelerator for a standard computing device. By separating data parallelism and time parallelism, processing data with certain conditions is improved. Specifically, large quantities of data such as video processing benefit from the present invention.

Although single pipelines have been illustrated and described above, multiple pipelines are possible. For multiple bitwise data, multiple stacks of these columns or pipelines of processing elements are used. For example, for 16 bitwise data, 16 columns of processing elements are used.

Additionally, although it is described that each processing element produces a result in one clock cycle, it is possible for each processing element to produce a result in any number of clock cycles such as 4 or 8.

There are many uses for the present invention, in particular where large amounts of data is processed. The present invention is very efficient when processing long streams of data such as in graphics and video processing, for example HDTV and HD-DVD.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A system for performing processing intensive computations comprising:
a. a data parallel system for performing parallel data computations; and
b. a time parallel system coupled to the data parallel system, wherein the time parallel system utilizes a pipeline of processing elements and a selection component to sequentially process data in parallel.

2. The system as claimed in claim 1 wherein the data parallel system and the time parallel system are physically separated.

3. The system as claimed in claim 1 wherein the pipeline of processing elements sequentially processes the data in parallel each clock cycle.

4. The system as claimed in claim 1 wherein the selection component is selected from the group consisting of a multiplexer and a file register.

5. The system as claimed in claim 1 wherein the selection component enables a processing element within the pipeline of processing elements to receive a result from a selected previous processing element within the pipeline of processing elements.

6. The system as claimed in claim 5 wherein the selected previous processing element is within a specified subset of the pipeline of processing elements.

7. The system as claimed in claim 6 wherein the specified subset of the pipeline of the processing elements includes a constant number of processing elements.

8. The system as claimed in claim 6 wherein the specified subset of the pipeline of processing elements includes 8 processing elements.

9. The system as claimed in claim 1 wherein the pipeline of processing elements is dynamically reconfigurable.

10. The system as claimed in claim 1 wherein the processing elements are individually programmable.

11. The system as claimed in claim 1 wherein the data parallel system further comprises:
a. an array of processing elements for performing a first set of functions on the data;
b. a sequencer coupled to the array of processing elements for sending an instruction to the array of processing elements; and
c. a direct memory access component coupled to the array of processing elements for transferring the data to and from a memory.

12. A system for performing processing intensive computations comprising:
a. a data parallel system including:
i. an array of processing elements for performing a first set of functions on a set of data;
ii. a sequencer coupled to the array of processing elements for sending an instruction to the array of processing elements; and
iii. a direct memory access component coupled to the array of processing elements for transferring the set of data to and from a memory; and
b. a time parallel system coupled to the data parallel system including:
i. a pipeline of processing elements for performing a second set of functions on the set of data; and
ii. a selection component for selecting a previous processing element within the pipeline of processing elements to receive a result from;
wherein the data parallel system and the time parallel system are separately configured.

13. The system as claimed in claim 12 wherein the pipeline of processing elements performs the second set of functions on the set of data each clock cycle.

14. The system as claimed in claim 12 wherein the selection component is selected from the group consisting of a multiplexer and a file register.

15. The system as claimed in claim 14 wherein the previous processing element is within a specified subset of the pipeline of processing elements.

16. The system as claimed in claim 15 wherein the specified subset of the pipeline of the processing elements includes a constant number of processing elements.

17. The system as claimed in claim 15 wherein the specified subset of the pipeline of processing elements includes 8 processing elements.

18. The system as claimed in claim 12 wherein the pipeline of processing elements is dynamically reconfigurable.

19. The system as claimed in claim 12 wherein the processing elements within the pipeline of processing elements and the array of processing elements are individually programmable.

20. A time parallel system comprising:
a. a plurality of individually programmable processing elements for processing data; and
b. a selection component for selecting a previous processing element from which to receive a result from.

21. The time parallel system as claimed in claim 20 wherein the plurality of individually programmable processing elements sequentially processes the data in parallel each clock cycle.

22. The time parallel system as claimed in claim 20 wherein the selection component is selected from the group consisting of a multiplexer and a file register.

23. The time parallel system as claimed in claim 20 wherein the selection component enables a processing element within the plurality of processing elements to receive a result from a selected previous processing element within the plurality of processing elements.

24. The time parallel system as claimed in claim 23 wherein the selected previous processing element is within a specified subset of the plurality of processing elements.

25. The time parallel system as claimed in claim 24 wherein the specified subset of the pipeline of the plurality of processing elements includes a constant number of processing elements.

26. The time parallel system as claimed in claim 24 wherein the specified subset of the plurality of processing elements includes 8 processing elements.

27. The time parallel system as claimed in claim 20 wherein the plurality of processing elements are dynamically reconfigurable.

28. A method of processing data comprising:
a. receiving data in a first processing element of a pipeline of processing elements;
b. processing data in the pipeline of processing elements wherein each processing element receives a result from one of a previous processing element; and
c. selecting the one of the previous processing elements to receive the result using a selective component if the previous processing element is not immediately preceding a present processing element.

29. The method as claimed in claim 28 wherein the selection component is selected from the group consisting of a multiplexer and a file register.

30. The method as claimed in claim 28 wherein the one of a previous processing element is within a specified subset of the pipeline of the processing elements.

31. The method as claimed in claim 30 wherein the specified subset of the pipeline of the processing elements includes a constant number of processing elements.

32. The method as claimed in claim 30 wherein the specified subset of the pipeline of processing elements includes 8 processing elements.

33. The method as claimed in claim 28 wherein the pipeline of processing elements is dynamically reconfigurable.

34. The method as claimed in claim 28 wherein the processing elements are individually programmable.

35. The method as claimed in claim 28 further comprising sending the data to a data parallel system for parallel data processing.
